(19) United States
(12) Patent Application Publication
(10) Pub. No.: US 2025/0198152 A1
(43) Pub. Date: Jun. 19, 2025

(54) Method for Producing Fiber Reinforced, Pozzolan-Coated Reinforcement Bar

(71) Applicants: Tracy McSheery, San Leandro, CA (US); Charles Weiss, Vicksburg, MS (US); Mine Ucak-Astarlioglu, Vicksburg, MS (US); Zach Spencer, San Leandro, CA (US)

(72) Inventors: Tracy McSheery, San Leandro, CA (US); Charles Weiss, Vicksburg, MS (US); Mine Ucak-Astarlioglu, Vicksburg, MS (US); Zach Spencer, San Leandro, CA (US)

(21) Appl. No.: 18/389,668

(22) Filed: Dec. 19, 2023

(51) Int. Cl. E04C 5/07; C04B 20/00; C04B 28/00; C04B 111/00

(52) U.S. Cl. CPC E04C 5/073; C04B 20/0052; C04B 28/003; C04B 2111/00637

(57) ABSTRACT

A method of providing a reinforced bar (rebar) is disclosed for improved strength and flexibility for use in construction. The method includes forming a fiber reinforcement bar or strip such that it is flexible and coating its surface with a pozzolan to react to the cement. The rebar further includes a cross section to support bending moments and tensile loads. Various embodiments include modifications to the rebar shape such as strips, ribbons, and twisted forms for improved flexibility and mechanical interaction. Pozzolan constituents can vary, and a binding agent, possibly dicyclopentadiene, may be used for fiber binding. Further treatment such as rolling, compression, and addition of holes can enhance the surface area and ease of assembly, respectively. The method can also include processes such as chemically bonding steel through a transition layer to the reactive powder, melting of a glass frit to bind the reactive powder coating, or transferring pozzolans to an epoxy or plastic binder. The aim of these methods is to enhance the performance characteristics of the rebar and optimize its usefulness in various construction applications.

### BACKGROUND OF THE INVENTION

Reinforcement bar or rebar is used to distribute compressive and tensile loads in concrete more uniformly, with the high compressive strength of large structures of concrete augmented by tensile strength provided by rebar. Concrete structures are a complex matrix of cement, aggregate, fiber for local distribution of tensile loads and to reduce cracking, additives such as fly ash, natural pozzolans, silica fume and others, to increase strength of the composite along with reinforcement bar. Silica fume and other fine particles react with cement and lime to fill in microscopic voids between cement particles. This reduces permeability and improves the bond between the paste and the aggregate and helps with the mechanical performance of high-strength concrete by creating compounds in interstitials between cement. Greater strength makes the structure stiffer, but the rebar position and moments inside the concrete also need to be improved to leverage this additional strength. Normally to prevent corrosion, steel rebar is placed 4 to 6 inches beneath the outer layer of concrete, which is the exact opposite of the best position to reduce flexing and increase structural load bearing. Ideally the tensile strength reinforcement would be on the outside of the flexing member, as the stiffness is proportional to the fourth power of the moment. Under bending, compressive loads such as a floor beam where the bottom of the beam is under tension as it sags and the top is under compression, become tensile loads, and rebar helps distribute the loading that would be a high compressive load on the top of the floor and a tensile load on the bottom of the floor into a more uniform load, especially if the Young's Modulus can be optimized for concrete. In traditional construction the modulus of elasticity of steel is about 200 GPa (29,000,000 psi), and the modulus of elasticity of concrete is around 30 GPa (4,350,000 psi). Further rebar allows joining in this example the structure of the floor to the structure of the walls and columns, creating an integrated network. For over 100 years, rebar has largely remained consistent as steel bars having ridges to keep them from easily pulling out of the concrete. The rebar is usually formed into cages or structures, and the concrete poured around them. As steel is easily corroded, and must be protected, more concrete is added to the outside of the rebar structure to protect the steel, increasing the cost and size of the structure as well as the weight creating a snowball effect requiring more support. Mechanically the stiffness is proportional to the diameter, so ideally the rebar would be as close to the skin of the structure as possible to provide maximum value. In earthquakes, strong winds and seasonal shifting, structures of any size can move, and the loads can exceed the strength of the concrete materials causing cracking. Water can intrude through the cracks and attack the steel causing rust, which expands almost five times, and can cause spalling and additional cracking, leading to failure of the structure. Fiber rebar was introduced to address the corrosion problems of rebar but the epoxy binder tends to be slick and despite a winding of a spiral on the outside to improve the mechanical binding, or adding grit to the surface, the pullout strength can be problematic. Since the spiral winding and grit are only bound by the epoxy, they only have the pullout strength of that area of epoxy, not the strength of the fiber. Since the fiber based rebars are stiff they tend to not be bendable in the field, limiting their utility unless preformed bends can be fabricated and then spliced together, making it more difficult and costly to build large structures. Steel rebar is heavy and requires additional labor or equipment to move and increasing time and cost. Fabricating the cages and structures often requires welding or metal ties that can cause rust, even before the concrete is poured. The rust can further reduce the pullout strength of steel as the iron oxides that form are weakly bound to the surface of the rebar and easily pulled out of concrete since there is no chemical bond. These steel structures are heavy and require cranes to move and connect, adding labor and time costs to building. By leveraging the lack of corrosion and the strength of composite materials, structural design can be improved, versus the standard methods that in many cases have built in workarounds for the limitations and failures of steel rebar. Composite rebars can be closer to the surface and lower the Effective Depth: the primary factor for stiffness of a beam or column is the distance between the centroid of the steel section and the farthest concrete fiber (effective depth). Placing the rebar farther from the neutral axis leverages its contribution to resisting bending, essentially increasing the effective depth and thus the stiffness. This is why beams with multiple layers of rebar, as long as they are spaced effectively, can be stiffer than those with a single layer at the center. The Moment of inertia (MOI) also plays a role as by placing the rebar further from the neutral axis, we increase the MOI, which quantifies a beam's resistance to bending deformation. A higher MOI means the beam will deflect less under the same load, or conversely, it will need a larger load to experience the same deflection. This means the stress strain induced elongation that the rebar would experience is also reduced. Ultimately, optimal placement of rebar for desired stiffness depends on various factors and should be determined by a qualified structural engineer considering specific beam design, loading conditions, and material properties. While these improvements are fundamental to structural design and cannot be patented, the designed products leverage the enabled improvements possible by using stronger, lighter, and less prone to failure materials which don't need to be protected by layers of concrete from the environment, creating additional advantages over prior solutions. This in turn can lead to better use of materials, less materials needed, and overall extension of the life of the building or structure, decreasing costs, greenhouse gas emissions, and providing significant energy savings. Further basalt and glass have similar coefficients of thermal expansion to concrete being several times lower than steel and almost a hundred times lower thermal conductivity, both reducing internal stresses caused by temperature.

The one embodiment relates to the field of construction, particularly in producing reinforced concrete using reinforcement bars with optimal tensile strength, pullout resistance and flexibility. The industry traditionally uses steel bars for reinforcement in concrete structures. However, despite its high tensile strength, steel is plagued with issues of corrosion over time. Additionally, producing steel requires high energy consumption and causes significant environmental pollution.

Furthermore, other alternative reinforcement materials such as bamboo or glass suffer from limitations in terms of durability, tensile strength and long lifetimes in practical applications. The alkali conditions in concrete can dissolve glass or organic materials over long periods of time. In addition, the endurance of some alternative materials to adverse environmental conditions and pests, mold or mildew or water damage, present considerable drawbacks.

Rebar, both steel and fiber based products, produced using the traditional methods often lack flexibility, ease of weaving into cages and meshes, and sufficient bonding with the surrounding cement. Therefore, research and development to improve existing rebar technology to ensure high performance, durability and reduced environmental impact is critically important for the construction industry.

The present embodiment addresses these issues by proposing a method to produce steel or fiber reinforced bars in wide but thin strips coated with a surface-reactive pozzolan. The creation of interleaved meshes, baskets or cages is facilitated, and the surface area available for the chemical reactions of the surface pozzolan with the surrounding concrete is increased. This innovative method is anticipated to result in enhanced rebar performance, increased concrete stability, and a significant reduction in labor cost and time in a more environmentally friendly way. Since the tensile strength of a particular composition is proportional to the area of a rectangle which is proportional to the width multiplied by the thickness, and the pullout strength is proportional to the perimeter which is proportional to twice the (width+thickness), while the stiffness is proportional to the width×thickness cubed, we can derive an optimized ratio of tensile strength, pull out strength and flexibility of the reinforcement providing the best mechanical solution for a particular usage.

### SUMMARY OF THE INVENTION

A preferred embodiment relates to a method of providing a fiber reinforced bar (rebar) with improved strength and flexibility for use in construction. The method includes forming a steel or fiber reinforcement bar or strip and coating its surface with a pozzolan to react in the cement. The rebar further includes a cross section to support bending moments and tensile loads. Various embodiments include modifications to the rebar shape such as strips, ribbons, and twisted forms for improved flexibility and mechanical interaction. Pozzolan constituents can vary, and a binding agent, possibly dicyclopentadiene, may be used for fiber binding. Further treatment such as rolling, compression, and addition of holes can enhance the surface area and ease of assembly, respectively. The method can also include processes such as chemically bonding steel through a transition layer to the reactive powder, melting of a glass frit to bind the reactive powder coating, or transferring pozzolans to an epoxy or plastic binder. The aim of these methods is to enhance the performance characteristics of the rebar and optimize its usefulness in various construction applications.

### BRIEF DESCRIPTION OF DRAWINGS

Turning now descriptively to the drawings, in which similar reference characters denote similar elements throughout the several views, the figures illustrate the electronic book of the preferred embodiment. With regard to the reference numerals used, the following numbering is used throughout the various drawing figures.

FIG. 1A-1B show exemplary illustrations of processes to form a rebar.

FIGS. 2-3 show exemplary analysis of rebar structures that embody the process of FIGS. 1A-1B as examples.

### DETAILED DESCRIPTION OF THE INVENTION

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

In the following paragraphs, the preferred embodiment will be described in detail by way of example with reference to the attached drawings. Throughout this description, the preferred embodiment and examples shown should be considered as exemplars, rather than as limitations on the preferred embodiment. As used herein, the “preferred embodiment” refers to any one of the embodiments of the invention described herein, and any equivalents. Furthermore, reference to various feature(s) of the “preferred embodiment” throughout this document does not mean that all claimed embodiments or methods must include the referenced feature(s).

This invention now will be described more fully hereinafter with reference to the accompanying drawings, in which exemplary embodiments are shown. Various embodiments are now described with reference to the drawings, wherein such as reference numerals are used to refer to such as elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the such as represent conceptual views or processes illustrating systems and methods embodying this invention. The functions of the various elements shown in the figures may be provided through the use of dedicated hardware as well as hardware capable of executing associated software. Similarly, suggested implementations shown in the figures are conceptual only. Their function may be carried out through the operation of varying the components, binders, modifying fabrication equipment, program logic, sensors and processes, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

The preferred embodiment relates to a method of providing a reinforcement bar, often referred to as rebar, used in the construction industry to strengthen concrete structures. Traditional rebars are commonly made from steel and are prone to corrosion over time. This method forms a fiber reinforcement bar or strip, thereby providing an efficient solution to address corrosion issues as well as increasing the overall toughness and flexibility of the rebar.

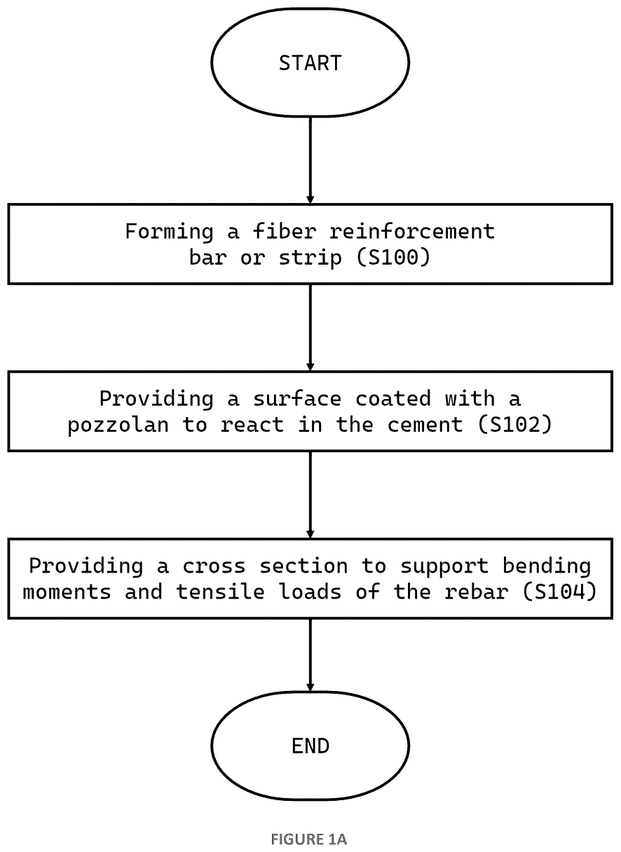

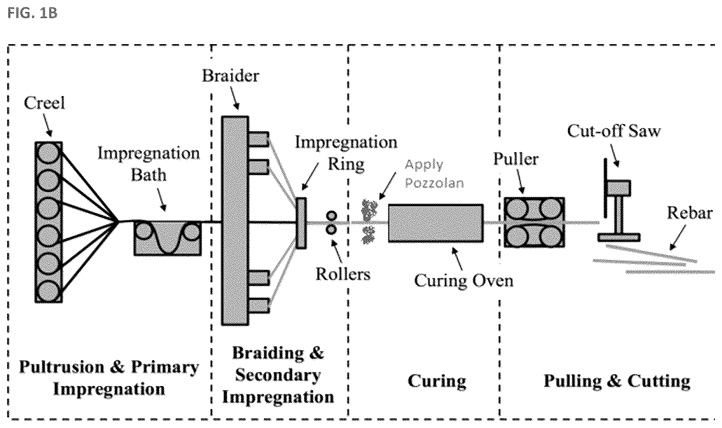

Turning now to FIG. 1A, an exemplary illustration of a process to form a rebar is shown that includes:
Forming a fiber reinforcement bar or strip S101, wherein said forming step is followed by a spraying step of a pozzolan onto said fiber reinforcement bar or strip, wherein said pozzolan has a size of up to microns; and a rolling step of said pozzolan into said fiber reinforcement bar or strip, wherein said rolling step is conducted with a roller.
Providing a surface coated with a pozzolan to react in the cement S102 matrix of the pultrusion material. The invention involves the spraying of pozzolans onto a pultruded form, followed by the use of a roller to embed the pozzolans into the surface area of the bar. The method offers several advantages, including improved strength and durability, cost-efficiency, and sustainability. Furthermore, it does not require complex or expensive machinery and can be integrated into the existing pultrusion process. The process of rolling the pozzolans into the surface ensures a lasting impact and prevents surface wear and tear. This invention provides an effective method of including the advantageous properties of pozzolans into the epoxy or plastic binder, making it an innovative and beneficial addition to the field of construction materials.
Providing a cross section to support bending moments and tensile loads of the rebar S103. The proposed method offers several advantages to the construction industry. Firstly, by enriching the surface of the pultruded form with pozzolans, it enhances the strength and durability of the composite material, reducing maintenance and repair costs. Additionally, the method is cost-effective as it does not require any complicated or costly machinery. Furthermore, pozzolans are a sustainable material that is abundant in nature, making it a great choice for use in construction materials. The rolling of the pozzolans into the surface embeds the particles deep into the matrix, ensuring a lasting impact and preventing surface wear and tear. Finally, the process is easy to implement and integrate into the existing pultrusion process. Therefore, this invention provides an effective and efficient way to include the advantageous properties of pozzolans into epoxy or plastic binders, making it a beneficial addition to the field of construction materials.

The initial step of the method comprises forming a fiber reinforcement bar or strip. A wide variety of fibers can be implemented in creating this reinforced product. These may include but are not limited to basalt, glass, steel, polypropylene or carbon fibers, strips or sheets. In creating the base structure, each of these varieties imparts unique properties to the final rebar formulation. For instance, while basalt or steel fibers, strips or sheets add tensile strength and toughness, polypropylene fibers enhance durability, impermeability, and resist cracking. The manufacturing process involves bundling these fibers tightly to form the rebar or strip, resulting in a significantly enhanced load-bearing capacity.

In the next step of the method, a surface of the formed rebar is coated with a pozzolan material. The pozzolan is a siliceous, or siliceous and aluminous material that possesses the ability of reacting chemically with calcium hydroxide in the presence of water to form compounds possessing cementitious properties. This coating leads to a concrete-rebar bond that is stronger and more durable, largely due to the pozzolanic reaction that occurs when the coated rebar is embedded in concrete. This chemical reaction further assists in enhancing the overall strength and durability of the concrete structure, and significantly reduces the risk of deterioration or rupture.

Additionally, the method involves providing a cross-section to the rebar, which is designed to support bending moments and tensile loads. The design and size of the cross-section are dependent on the kind of load the rebar is expected to carry. This cross-sectional design aids in effectively distributing the applied forces across the length and breadth of the rebar, thereby preventing the concentration of stresses at a single point, which can lead to failure. The size can be varied according to the specific construction needs, making this method highly adaptable and customizable.

The method of providing a fiber reinforcement bar as disclosed herein offers several advantages over traditional steel rebars. One of the primary advantages is the prevention of corrosion, as the fibers used in this method are inherently resistant to rust and chemical attacks. This eliminates the need for additional protective measures that are typically required when using steel rebars.

Another advantage pertains to the increased strength and durability. The fiber reinforcement bar produced through this method is capable of bearing higher tensile, and shear loads compared to traditional steel rebars. This means that less quantity of rebar is needed for the same strength, thus, reducing the weight and cost of the construction. Due to the specific density of basalt and carbon fiber being lower by almost four times that of steel, and the specific strength being much higher, as well as the ability to make the cage larger and closer to the surface of the structure, as described above, a rebar cage assembly of given strength might be four to ten times lighter than a steel rebar cage of similar strength, greatly lowering the costs and difficulty of transportation and installation. This is especially valuable in fabrication of large rebar cages or structures offsite and lowering them into the ground or water.

The final advantage is in the method's overall versatility. By modifying the composition and the size of the cross-section of the fiber reinforcement bar according to structural requirements, one can optimize the performance of the rebar for various specific applications. This is particularly significant in the construction of structures subject to varying loads and environmental conditions. In conclusion, the method presents an innovative way of producing rebars that outperform conventional steel rebars in numerous aspects.

FIG. 1B shows a process for forming the rebar of FIG. 1A. First, in a pultrusion and primary impregnation step, using a creel the materials are spooled and provided to an impregnation bath. From the bath, the materials are provided to a braider and then to an impregnation ring and then flattened with rollers in a braiding and secondary impregnation step. Next, the pozzolan is added to the rolled materials before they are placed in a curing oven for curing. In the next step, the materials are provided to a puller that stretches the cured pozzolan covered materials. A saw is applied to the cured pozzolan materials to cut them to predetermined length to form the rebars.

The preferred embodiment pertains to a unique type of rebar, or reinforcing bar, designed to provide reinforcement to structures such as concrete. The rebar, in accordance with this invention, is constructed in the shape of a strip or ribbon instead of the traditional cylindrical form. This innovative design lends the rebar enhanced flexibility. The strip or ribbon shape allows the rebar to better flex and move with the structures it is reinforcing, lowering the chances of cracking or damage in response to external forces such as wind, earthquake, or temperature fluctuation. Moreover, the width of the rebar helps to transfer bending moments effectively throughout the structural member. This not only increases the structure's resistance to bending and torsion but also assists in equitably distributing the load pressures, therefore enhancing the overall strength and durability of the structure.

The method of manufacturing this unique rebar involves a variety of steps that ensure it maintains its innovative form and functionality. To start with, the raw material, typically composed of basalt fiber, or a combination of fibers and steel, is shaped into the strip or ribbon design. During this stage, care is taken to adhere to precise dimensions and ensure its required thin size and flexible property. The rebar then undergoes a binding process that helps maintain necessary tensile strength and durability. Further, to facilitate superior adherence with concrete or other construction material, the rebar strip is often given a textured surface. Once the mechanical shape is formed, a pozzolan coating is added that is thereby mechanically bound to the surface. By using a rectangular surface instead of a cylindrical surface, for the same cross section area, the surface area is increased, providing more active surface area for pozzolan coating and thereby increased pullout resistance. This could be achieved via methods like pattern rolling or applying to the surface, or rolling pozzolan on the top and bottom of the surfaces. Such design, coupled with high-quality manufacturing processes, significantly contributes to the superior performance of the rebar.

The strip or ribbon shaped rebar finds applications in a wide range of construction projects. Its high bending flexibility makes it specifically suited for usage in structures with complex shapes and increased demands for flexibility, such as bridges, tunnels, high-rise buildings, piers, seawalls, and any structure in earthquake-prone areas. The flexible rebar is also ideal for retrofitting older structures to improve their resistance to natural disasters as it can be closer to the surface than traditional rebar which needs several inches of protective concrete to prevent corrosion. As a consequence, this invention is expected to revolutionize the construction industry, introducing new standards of strength, reliability, and adaptability in structural design. It marks a significant advancement in the field of construction, combining engineering ingenuity with practical application to deliver a product that dramatically improves the longevity and safety of civil structures.

The preferred embodiment relates to a unique method utilizing pozzolans as a primary component to improve rebar pullout strength. The term, ‘pozzolan’, as used herein, refers to a range of materials, which includes, but is not limited to, clinker, cement, clay, and volcanic rock. These materials have been identified by prior investigations for their pozzolanic property, which, in essence, refers to their ability to acquire cementitious properties when combined with water and calcium. The identified pozzolans exhibit strong bonding characteristics, making them an excellent choice for a range of applications, particularly for constructing, reinforcing, or repairing structures where durability and resilience are imperative.

The method stipulated herein aims to exploit the unique properties of these selected pozzolans. Particularly, clinker, exhibits an exciting blend of hardness and water-resistance but will react with cement, known for its remarkable adaptability and cost-effectiveness, and serves as an excellent binder, enhancing bond strength. Further, clay, a readily available material, is manipulated for its superior plasticity and hardening capabilities when exposed to heat, thereby improving the thermal performance. Volcanic rock, with its porous structure and inherent resistance to harsh environmental conditions, contributes to the overall toughness of the applied mixture. Through selection of the best material for a particular building method, an optimal balance is achieved between the cost-effectiveness and the performance efficiency of the resultant construction material.

The invention envisages a procedurally defined application method to optimize the use and interaction of these materials. The first step involves identifying the optimal proportions of the individual pozzolans, factoring in their inherent properties and the specific requirements of the application. This is followed by a meticulous mixing process to ensure homogeneous integration. The robust mixture is then applied as needed and subjected to appropriate treatment to facilitate the development of strong bonds. This method's effectiveness lies in promoting a synergistic interaction between different types of pozzolans, thereby enhancing the overall mechanical and chemical characteristics. Consequently, the method paves the way for the development of construction materials exhibiting enhanced durability, improved resistance to environmental impact, and optimized cost-effective application.

The preferred embodiment relates to a method of claim 1, involving the utilization of pozzolan in the context of creating an architectural structure or compounding material. The Pozzolan disclosed in this context comprises one of the following elements: clinker, fly ash, silica fume, rice husk ash, slag cement, or metakaolin, therefore enhancing the manufacturability and sustainability of the overall material. These pozzolanic materials, derived from various industrial by-products and natural sources, are known for their significant reactive silica and/or alumina content, which chemically reacts with calcium hydroxide at ordinary temperature and in the presence of moisture to form cementitious compounds. Each component has distinct properties that confer certain benefits when used as a pozzolan in material production such as enhanced resistance to sulfate attack, increased durability, reduced permeability, and improved compressive strength.

In this method, fly ash, a by-product of coal combustion in power plants, is leveraged for its beneficial properties such as improved workability and increased ultimate strength. Silica fume, a by-product of high-quality silicon metal or ferrosilicon alloys, which significantly enhances strength and durability attributes of the finalized compound due to its high level of purity is also utilized. Rice husk ash, an agricultural waste product rich in reactive silica, has proven effective in increasing the strength and durability of concrete, thus offering economic and environmental benefits. Slag cement, a by-product of iron production, is characterized by its latent hydraulic properties that result in long-term strength gains while improving the overall hardiness and density of the concrete mix. Metakaolin is a processed kaolinite that imparts pozzolanic properties and mitigates detrimental alkali-silica reactions, thus improving resistance to chemical attack and enhancing durability.

In use, the method provides a versatile and eco-friendly approach to the creation of concrete and other construction materials. By utilizing by-products from various industries, this method serves a dual purpose of waste management and the production of high performance, durable construction materials. Moreover, this method increases the understanding of the effectiveness and potential uses of pozzolan to the wider construction industry, thereby promoting a multi-faceted strategy that optimizes utilization of raw material resources, fosters environmentally friendly practices, and contributes to the sustainable development in the construction industry, lowering the overall cost by increasing the lifetime of the structure. Ultimately, the patent outlines a systematic and innovative method that harnesses the potential of varied pozzolan materials to create high-quality construction material.

The preferred embodiment refers primarily to a method for reinforcing building materials, specifically concrete or other similar materials, with rebar which is composed of fibers that have been bound with dicyclopentadiene, or another bonding agent. Reinforcement bar or rebar has become an integral part of construction due to its ability to add tensile strength to structures. Traditional methods employed to protect steel rebar from corrosion involves coating it with epoxy resins or other suitable materials. These materials can actually concentrate corrosion, in some cases, defeating the purpose of the coating, as well as decrease pull out strength of the rebar. This invention seeks to further improve and extend the useful life of said rebar through an innovative way of modifying the traditional geometry to increase the flexibility allowing it to be easier to be used on the jobsite, and applying another layer of protective coating of the individual fibers and internal strips or materials against long term corrosion.

The invention presents a detailed process that involves initially binding the rebar's fibers with a bonding agent, preferably dicyclopentadiene. The bonding agent serves to bind the fibers of the rebar together to provide an integral structure. The choice of dicyclopentadiene comes from its unique properties, including excellent resistance to environmental factors, corrosion resistance, and its compatibility with the rebar's material and is already accepted in the fiber rebar industry. However, regardless of the specific bonding agent used, the method ensures that such agent permeates thoroughly into the rebar, to create a cohesive and solid composite that resists separation even under pressure, flexing, or harsh conditions. This allows the complete integration of the rebar with the structural material, providing an increased load bearing and shear strength to the building elements in which this rebar is used.

Finally, the invention divulges the method of applying the reactive layer to the rebar due to the coating of a pozzolanic material. Pozzolans are siliceous or siliceous and aluminous materials which in itself possesses limited cementitious properties but when in finely divided form and in the presence of moisture, they chemically interact with calcium hydroxide forming compounds possessing cementitious properties. This coating not only aids transferring shear in concrete from a tensile load to a compressive load but also contributes to the overall strength of the concrete. Applying this double layer of protection not only enhances durability of the reinforced elements but also increases their performance and longevity, making it a more efficacious solution for construction purposes.

The preferred embodiment relates to a unique, innovative & facile method wherein the principle object is the mechanical binding of strips of reinforcement bar due to the modification of the shape allowing cages and meshes to be efficiently and quickly woven. For this purpose, the invention adopts a configuration in which the shape of the strip is altered using mechanical fasteners, pressure or other physical means. The fabrication of the structure is carried out such that the modified strip enables easy and rapid weaving into various structures such as cages, meshes or other lattice-like arrangements. The mechanical binding of the strip due to the transformation can also ensure the dimensional stability and effectiveness of the constructed structures, thereby providing a durable and robust solution.

The potential applications of this invention are vast, including but not limited to, construction, agriculture, building, and transportation industries. In the construction industry, the invention could be used in scenarios such as reinforcing concrete or forming grid structures. In agriculture, the invention could be used to make irrigation canals or structures for walls. In buildings, the incorporation of stronger, lighter, and corrosion resistant rebar will increase the life of the building and resistance to earthquakes and natural disasters. In transportation, bridges, overpasses and other structures can be quickly constructed on site, leveraging the lightweight materials, or even constructed off site and transported to the location, being on average approximately four to eight times lighter for a given strength and stiffness.

There are several advantages offered by this invention. Firstly, the mechanical binding process due to the modified shape ensures a high level of flexibility in the constructed structures, making them adaptable for a wide array of applications. Secondly, the swift weaving process can lead to time and labor savings, thereby making it a cost-efficient solution for many industries. Lastly, the robustness and durability of the resultant structures can increase the shelf life of the said entities. Therefore, this invention, by virtue of simple, efficient, and versatile design, satisfying most, if not all, practical framework requirements, is a noteworthy contribution to the arena of mechanical design and related industries.

The preferred embodiment relates generally to an innovative method for maximizing the structural utility, adaptability and flexibility of strips oftentimes utilized in various industrial and construction sectors. The method includes a structural enhancement technique wherein the initially linear strip is strategically split or fractured into subsequent fragments. This enables the integration of other strip components at multiple angles specifically at 90 degrees or other predetermined angles.

Primarily, this invention is aimed at providing optimal mechanical interaction between the original strip and the subsequently affixed strips. Upon fracturing the original strip, the subsequent sections are hence enabled to host or integrate the addition of supplementary strip elements. These added strips can be inserted at distinctive angles, optimally a right angle i.e. 90 degrees or certainly any other required angle based on specific requirements. This arrangement can result in mechanical interaction that drastically bolsters the structural robustness of the assembled strips. The resultant conglomerate of interlocking strips fosters biomechanical advantages such as reinforced structural stability, enhanced resistance to strain and a substantial boost in the overall rigidity. Unlike steel rebar which has to be welded or mechanically joined to create cages or structures, but never actually bonds with the concrete, but is surrounded by it, the reactive nature of the surface causes the surrounding concrete to bond to the structure holding it together and more uniformly distributing the loads.

Furthermore, the versatility provided by this method promotes enormous operational adaptability. The variety of angles at which additional strips could be incorporated introduces a staggering array of structural configurations, hence prolonging the functional shelf-life and practical applicability of the strips in several sectors. The method even contributes to the cost and resource efficiency as the same strip can be retrofitted according to the evolving requirements, thus eliminating the need for frequent replacements. The preferred embodiment could potentially revolutionize modern construction techniques, enhancing both their efficiency and optimum operation.

The preferred embodiment pertains to a reinforcement system for concrete structures utilizing an adaptable, resilient strip that can be incorporated in close proximity to the surface of a concrete structure without compromising the surface strength. Steel rebar normally requires several inches of protective concrete covering to protect the steel from corrosion. This is mechanically not as strong and stiff as the same load carrying capability closer to the surface, thereby allowing stronger and lighter structures, which could use less concrete in the final design, further increasing the load carrying capability of large structures This novel strip is empowered with the inert trait of fiber reinforcement and binder which neither reacts chemically with the surrounding concrete nor negatively affects the intrinsic characteristics of the concrete structure. The surface toughening effect is made obtainable via the inclusion of this strip, providing a supplemental strength layer to the original concrete structure.

As the name suggests, the fiber reinforcement comprised in the strip provides added durability to the structure. These fibers, whether synthetic or natural, have high tensile strength properties. When combined with the binder, the fibers form an inert, robust layer that enhances the overall integrity of the concrete structure. The binder, which can use various materials such as dicyclopentadiene, polymer or resin, acts as an adherent that can maintain the fibers in the desired arrangement, providing a structured yet adaptable reinforcement system.

Notable advantage of the innovative strip lies in its adaptability and easy incorporation into almost any shape of concrete structure, while not having an adverse effect on the strength and durability of the surface. This careful design allows the strip to provide reinforcement without any significant impact on the aesthetic features of the concrete structure. Furthermore, this reinforcement method can be used in new construction and also utilized as a retrofitting solution that can extend the life and improve the serviceability of existing structures. Thus, the invention revolutionizes the traditional approaches to enhance the strength and durability of concrete structures.

The invention relates to an innovative method for the manufacture and design of a strip wherein the strip is twisted along its long axis. This strip, which could be made from an assortment of materials such as basalt fiber, carbon fiber, glass fiber or a fabric thereof, depending on the intended use and desired properties, is manipulated in such a way that it gains a unique twisted structure along its longitudinal axis. This twisting process enhances the traditional structure of the strip, offering it a distinct shape and altering its physical properties, including but not limited to, increased tensile strength, flexural rigidity, and potential twisting resistance.

In the preferred embodiment of the invention, the strip undergoes a deliberate deformation process where it is twisted along its long axis, thus creating a ratified dimensional configuration that was previously unobserved in the standard design of such strips. By integrating a helical alteration on an otherwise linear strip, the structure becomes notably different. The now twisted strip appears spiral-like, presenting a non-planar morphology, hence imparting enhanced dimensional stability and uniform stress distribution when subjected to various forces, which is a considerable advantage in many applications.

Further, the method of formation of this twisted strip involves a controlled process to precisely delineate the degree of twist. The degree of twist can be manipulated as per the requirements of the specific application of the end product. This manipulation intends to optimize the strip properties to better withstand loads, resist deformation, and offer better functionality. The twist could also offer decorative effects especially for strips used in aesthetic applications. Therefore, this unique method of creating a twisted strip along its long axis not only increases its functional efficiency but also adds to its aesthetic appeal. This comprehensive design method is poised to challenge conventional approaches and foster substantial enhancements in various industrial applications.

This invention relates to a method that aids in the process of creating integral and efficient formwork or rebar cages. The said rebar cages are often used in the construction industry as a structure that is cast into concrete to provide improved tensile strength. These cages are vital to the structural integrity of many concrete structures and are especially significant in sizable construction projects, such as bridges, buildings, highways, etc.

The essence of this invention lies in the unique manner in which the strip of the rebar cage can be split. This innovative split-strip design drastically simplifies the assembly process and allows for the easy creation of interleaved baskets or cages. The method enhances the traditional approach by permitting a smoother integration of vertical and horizontal sections of the rebar cage or structure, with less labor and also maintains or increases the structural integrity of the whole system. The new design facilitates efficient and reliable cage construction, even for cages of complicated design or large scale, without compromising the quality or the structural strength of the cage.

The implementation of this invention leads to substantial cost and time savings, with an aim to streamline operations, reduce assembly mistakes, and improve the overall quality of the construction process. Furthermore, this system allows for greater flexibility in the design and assembly of the rebar cage, enabling adaptation to virtually any shape or structure. This method could considerably change the current construction practices, making the process simpler, more efficient, and cost-effective. As a patent, it is an advancement that serves a significant role in improving construction techniques and ensuring the feasibility of large-scale construction projects in a safer and more efficient manner.

The preferred embodiment relates to an improved method for enhancing chemical reactions between pozzolan material bound to rebar and surrounding concrete whereby the surface of the rebar is physically manipulated by rolling or compressing. This physical manipulation aims at expanding the available surface area of the rebar for the chemical reactions. The process is executed on the rebar before it is incorporated into the concrete framework. The object of this invention is to significantly increase the strength, resilience, and longevity of the concrete-framework structures in an economical and efficient manner.

The rolling or compressing of the rebar's surface can be executed using a range of techniques and instruments. This expands the surface area of the rebar to allow for more reactions between the pozzolan and the surrounding concrete. By virtue of this methodology, a far greater surface area of the rebar is exposed rendering the whole bonding process more proficient. Additionally, the new configuration of the rebar, post rolling or compression, increases surface area without requiring an increase in size or volume of the rebar. This provides more areas for interaction and consequently, enhanced bond strength with the embedding concrete and the pozzolan.

Furthermore, the expanded surface area allows for the pozzolan material to bind more efficiently with the rebar, thereby improving the overall reactivity of the pozzolan with the surrounding concrete. The proficient interaction between pozzolan and concrete improves the structural integrity of the construction immensely. This could translate to safer and more durable infrastructure that requires less maintenance and repair work. Furthermore, this can result in significant cost savings and resource efficiency in the long run, making the construction process more sustainable. The variation in rolling or compressing techniques allows for the method to be catered to specific rebar sizes, properties of pozzolan, and the particularities of the construction project.

The preferred embodiment relates to a method of claim 1 wherein the holes and mechanical forms are impressed in the strips to allow ease of assembly with fasteners. The procedure involves the strategic placement and formation of holes within and mechanical forms on the strips. The objective is to accommodate easy assembly with fasteners, hence enhancing the overall functionality, adaptability, and usability. The mechanical forms reiterated above can be but not limited to ridges, slots, tabs or other forms designed to contribute to mechanical interconnection, stabilization or securing purposes. The invention is oriented towards providing a more convenient solution for assembling or disassembling objects efficiently.

These mechanical forms and holes are manipulated, either carved, pressed, or molded, into the strips using various methodologies and techniques. This process ensures that the fasteners, which can include screws, bolts, clips, or others, can easily fit into and securely attach to the holes and mechanical forms, respectively, without welding, excessive force or additional tools. The method thus helps to promote ease of installation and removal. It also increases the applicability of the strips in varying industries such as construction, automobile, technology, etc.

This invention's exemplary embodiment includes the steps of identifying the appropriate locations for creating the holes and impressing the mechanical forms on the strips, next performing the impression of the holes and forms using compatible devices or tools, and finally, assembling the strips using the fasteners. The positions for the holes and forms can depend on several parameters like the design of the object to be assembled, strength required, safety considerations, etc. This new methodology provides significant benefits in terms of reduced assembly time, lower material waste, increased reliability and compatibility with different types and sizes of fasteners.

The preferred embodiment is a rectangular bar or strip with a preferred bending direction, strategically designed for enhanced mechanical performance and robustness in structural applications. This embodiment extends beyond traditional configurations and infuses advanced methods and materials to create a high-performing, versatile unit. The unique preferred bending direction design offers superior flexibility and resilience against varying operational stresses, ensuring the bar maintains structural integrity in diverse conditions. Primarily, it provides an efficient stress distribution across the bar, reducing the risk of deformation or breakage under load. Furthermore, the rectangular shape enhances stability, offering a broad base that effectively withstands pressure and impacts, while the edges promote improved grip and handling.

One of the invention's significant features is its enhanced pull-out strength. This characteristic directly applies to the bar's interaction with surrounding materials in structural systems, primarily cement. The improved pull-out strength indicates a higher resistance to potential displacement or extraction once the bar has been integrated into a cement structure. Such heightened strength is fundamentally critical in construction applications where stability and durability are paramount. Particularly for vertical or inclined structures, maintaining the robust connection between reinforcing bars and cement is crucial for overall structural safety and longevity. Therefore, boosting the bar's pull-out strength significantly contributes to the structural system's effectiveness and resilience to external forces.

The key technical appeal behind this enhanced pull-out strength is generated through the adhesion of a pozzolan to the surrounding cement. This feature puts into practice material engineering principles, leveraging the use of pozzolanic material—any one or combination of clinker, fly ash, volcanic ash or other pozzolan typology—as a binder with the cement. When mixed with water, pozzolanic material chemically reacts to create a stronger, more durable cement paste consistent with a highly resistant matrix. The inclusion of pozzolan essentially aids in forming a tighter, more secure matrix around the bar, improving its adhesion to the surrounding cement, hence bolstering its pull-out strength. This innovative integration of a pozzolan represents a significant technological advancement enhancing durability, long-term performance, and environmental sustainability given the inherent properties of pozzolan in cement and concrete technology.

The preferred embodiment relates to a novel method for enhancing the performance and durability of rebar through applying a specially designed reactive powdered coating onto the now flat larger surfaces of the rebar. The inventive coating technique significantly augments the resilience, structural integrity, and lifespan of rebars, thereby providing superior reinforcement to construction structures. The reactive powdered coating exhibits a unique formulation that includes a variety of chemical reactants and is formulated to perform a reactive process upon application, leading to an integrated, cohesive and durable binding layer.

With the advent of the invention, applying a reactive powder coating on basalt or other fiber rebar involves a meticulous process of deposition. An industrially compatible method, the procedure primarily commences with pre-preparation activities that include applying by dry powder coating to the rebar surfaces before the fiber binder has set, followed by the removal of excess reactive powder coating. The reactive powder coating is uniquely designed to contain chemical constituents that, upon application to the rebar surface are mechanically bound as the material binding the fibers, such as dicyclopentadiene or epoxy sets or polymerizes, reacts in a controlled manner to form a hard, durable, and performance-enhancing coating layer. The application of the reactive powder is typically carried out using a well-established method like spraying, dipping, or rolling, allowing for a uniform and smooth coating over the rebar surface.

The invention exhibits several merits over the traditional coating procedures used for rebars. For one, integrating a reactive powder coating to the rebar, vastly improving its resistance to physical and corrosion-related damages distributing the loads continuously along the rebar, versus mostly at bends or ridges. Furthermore, this reactive process results in a tightly bonded and integrated coating, providing enhanced grip for the concrete to hold onto, thus contributing to greater structural stability and safety. Moreover, the unique composition of the reactive powder coating can be modified to cater to different operational prerequisites, adding to the versatility of the invention. Economically viable and environmentally benign, the inventive approach opens up new routes for manufacturing better-performing, longer-lasting rebars, thereby playing a pivotal role in advancing the construction industry.

The preferred embodiment relates to a unique method of chemically bonding rebar to surrounding concrete through a transition layer to a reactive powder. This innovative process is primarily designed to enhance the bond between the rebarand the reactive powder, thereby resulting in a product stronger and more durable against stress, impact and environmental influences. Traditional bonding methods using non-reactive sand or grit or abrasives, rolled onto a cylindrical surface, often fail to secure a flawless chemical bond, which can lead to weakened structures and products. This invention addresses the concern by introducing a distinctive transition layer that acts as a conduit for the chemical bonding process between steel and reactive powder.

The invention involves a sophisticated process of integrating pozzolans, belonging to the class of siliceous or siliceous and aluminous materials, into an epoxy or plastic binder. This innovative technique is designed to enhance the efficiency and durability of construction materials, especially concrete, giving them superior physical and chemical properties. Pozzolans, recognized for their prominent role in improving concrete performance, have been strategically chosen to blend with particular binders—to exert their robust reactive forces which are combined with the inherent strength of binders to create a highly durable and enduring material.

At the heart of this invention lies the effective transfer of pozzolanic materials onto the epoxy or plastic binder. In this method, pozzolanic materials are meticulously introduced onto the binder—ensuring seamless distribution as well as thorough intermingling. The binder, in combination with the pozzolans, forms a robust matrix that adequately binds all components together. The transfer process ensures that there is a uniform distribution of pozzolanic materials throughout the surface of the composite material—for a homogeneous dispersion by eliminating regional concentration variances and maximizing cohesive potential. This blend manifests itself in an advanced composite material that demonstrates enhanced performance characteristics such as increased tensile strength, improved load distribution, better fatigue resistance, and increased pull out strength.

Through a combination of a well-studied selection of pozzolan materials and a judiciously designed transfer process to epoxy or plastic binders, the invention provides a novel class of enriched, powerful building materials. The invention's comprehensive design brings forth a new standard for durability and longevity, contributing to economically efficient construction methodologies with extended operational life and reduced maintenance. In addition, the method also offers environment-friendly solutions by enabling the use of industrial by-products as pozzolans. Not only does this method contribute to material improvement in the construction industry, but it also conducts a brilliant act of recycling waste materials, paving the way for sustainable construction practices.

The invention described herein constitutes a novel method of integrating pozzolans-A group of supplementary cementitious materials derived from natural volcanic ash or industrial waste like silica fume and fly ash with an epoxy or plastic binder. These pozzolans are transferred to the binder through a unique chemical welding or gluing process which ensures effective adhesion and increased durability. The bifunctional approach has been found to offer compelling advantages in terms of strengthening the structural integrity of the final product and mitigating stress-cracks or deformation. The transfer procession is innovative and provides a medium for the microscopic pozzolanic particles to react chemically within the epoxy binder to exploit their potential filler and reinforcing capability.

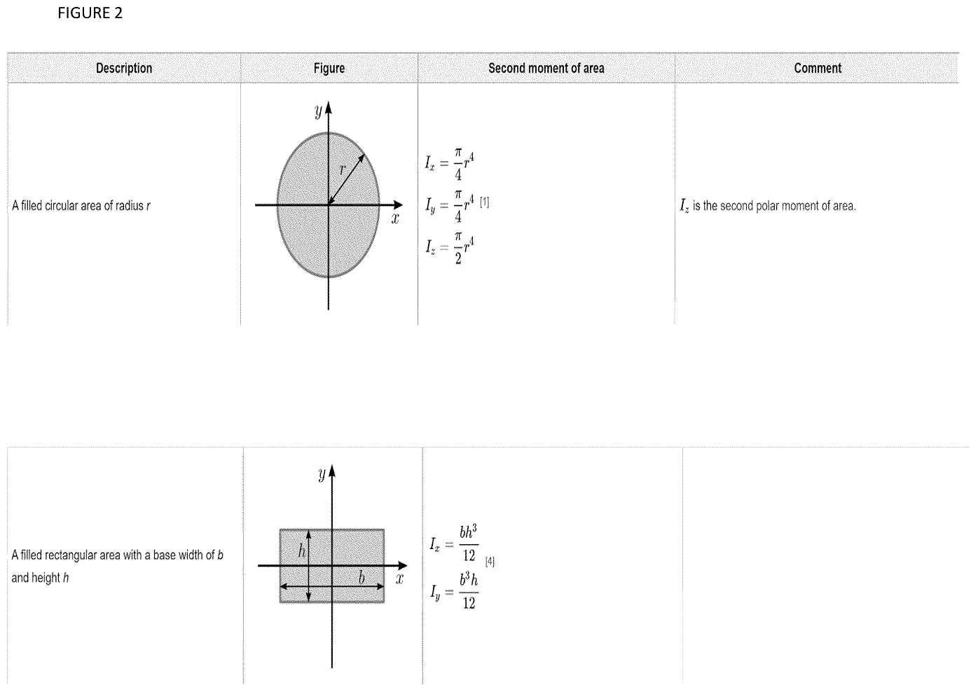

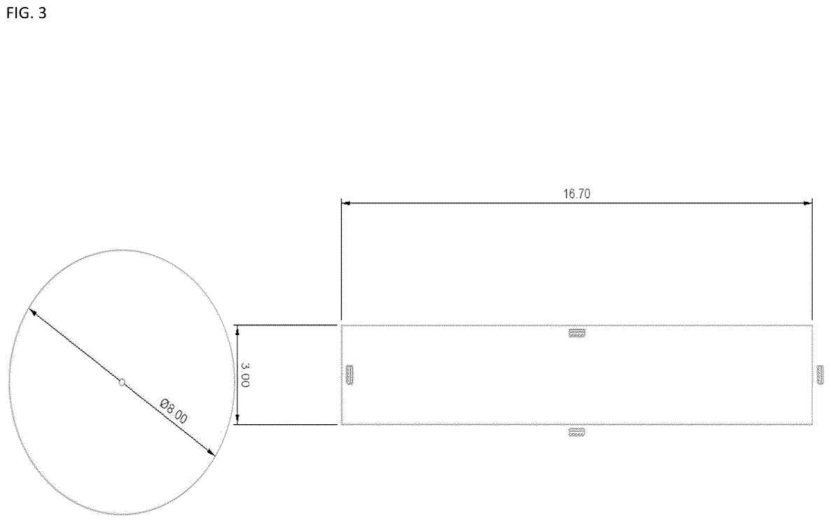

FIGS. 2-3 show exemplary analysis of rebar structures that embody the process of FIGS. 1A-1B as examples. The rebar cross-sections can be circular or rectangular as illustrated therein. As shown in FIG. 3, exemplary material dimensions for various embodiments 3-8 are:

| Rebar | #3 | #4 | #5 | #8 |
|---|---|---|---|---|
| Imperial (inch) | ⅜ | ½ | ⅝ | 1 |
| Metric (mm) | 9.5 | 12.7 | 15.875 | 25.4 |
| Area of Circular Profile | 70.9 | 126.7 | 197.9 | 506.7 |
| Perimeter Circular Profile | 29.8 | 39.9 | 49.9 | 79.8 |
| Rectangular Profile (3 mm) | 23.63 | 42.23 | 65.98 | 168.90 |
| Area of Rectangular Profile | 70.9 | 126.7 | 197.9 | 506.7 |
| Perimeter Rectangle | 53.3 | 90.5 | 8.0 | 343.8 |
| Ratio of Perimeters | 1.8 | 2.3 | 2.8 | 4.3 |

The potent embodiment of this invention encompasses the creation of a final pultrusion form exhibiting a smooth surface. The pultrusion process involves the pulling of raw materials such as fibers and resins through a die to create a continuous composite profile. This method enables the production of long, continuous pieces and produces finished products that are lightweight yet incredibly strong. The created form is further subjected to a ‘spraying’, ‘dusting’ or ‘immersion’ step which involves coating or dusting the surface with fine pozzolan material.

Following the spraying or coating phase, the material is further processed by rolling or working the sprinkled pozzolans into the surface of the formed profile. This rolling process is geared towards ensuring the anchored assimilation of the pozzolan particles into the epoxy or plastic binder. The rolling action generates sufficient pressure to facilitate the greater engagement of the materials, creating a heavily induced and compacted surface layer. The practical outcome from this step is an improved and permanent bond between the pozzolan particles and the binder material. The result is a high-quality, robust, and durable composite piece that stands exceptional in its use in various industrial applications. The invention in its entirety offers a productive and novel process in the realm of composite material manufacturing.

The preferred embodiment is related to the field of construction materials, specifically a novel method for transferring pozzolans to epoxy or plastic binders in pultruded structures. Pultrusion is a continuous process used to manufacture composite materials with constant cross-section. The method involves spraying a finished, smoothly pultruded form with pozzolans then dusting its surface and rolling it into the surface layer of the bar. Subsequently, the treated bar is left to settle, leading to a binder enriched with pozzolans. Pozzolans are materials that contain siliceous and aluminous composition, often derived from volcanic ash, and they add to the overall durability and strength of the composite material. The integration of pozzolans into the binder presents enhanced cementitious properties, improving the structural integrity of the final product.

In the proposed method, the first step involves spraying the pozzolans onto the pultruded form. This spraying process could involve a range of technologies, such as aerosol or airless spraying. The objective is to create an evenly distributed layer of pozzolans on the surface, which could be facilitated by various pneumatic or hydraulic methods. Once the pozzolans are sprayed onto the surface, the surface is dusted to ensure an even and thorough layer. Following this, a roller is used to embed the pozzolans into the surface area of the bar. This is akin to rolling out dough with a rolling pin, ensuring a homogeneous composition. This step results in a bar whose surface is enriched with pozzolans, creating a strong and durable construction material.

Additionally, the inventive method offers economical and technical benefits. By enhancing the durability and strength of the composite material, it leads to cost-efficiency and reduced maintenance for the construction industry. Moreover, pozzolans have been recognized as sustainable materials for construction purposes due to their abundant availability. Also, the proposed technique does not require complicated or costly machinery and can be integrated seamlessly into the existing pultrusion process. The process of rolling the pozzolans into the surface embeds the particles deep into the matrix, ensuring a lasting impact and preventing surface wear and tear. Consequently, this invention provides an effective method of including the advantageous properties of pozzolans into the epoxy or plastic binder, making it an innovative and beneficial addition to the field of construction materials.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the preferred embodiment have been described above, it should be understood that they have been presented by way of example only, and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the preferred embodiment. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the preferred embodiment should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the preferred embodiment. Various modifications to these embodiments will be readily apparent to those skilled in the art, and the generic principles defined herein may be applied to other embodiments without departing from the spirit or scope of the invention. Thus, the preferred embodiment is not intended to be limited to the embodiments shown herein but is to be accorded the widest scope consistent with the principles and novel features disclosed herein.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. The Abstract of the Disclosure is provided to comply with 37 C.F.R. &sect; 1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

1. A method of providing a reinforcement bar (rebar), comprising:
forming a fiber reinforcement bar or strip;
providing a surface coated with a pozzolan to react in the cement;
providing a cross section to support bending moments and tensile loads of the rebar.

2. The method of claim 1, wherein the surface is rolled or compressed to increase the surface area available for the chemical reactions of the pozzolan bound to the rebar with the surrounding concrete.

3. The method of claim 1, wherein pozzolans are transferred to the epoxy or plastic binder by spraying a finished smooth pultruded form and dusting the surface with pozzolan and rolling it into a surface of the bar.

4. The method of claim 1, wherein pozzolans are transferred to the epoxy or plastic binder through a chemical welding or gluing process of spraying the finished smooth pultruded form and ‘dusting’ the surface with pozzolan and rolling it into the surface

5. The method of claim 1, comprising transferring pozzolans to the epoxy or plastic binder.

6. The method of claim 1, wherein the bar consists of a steel strip embedded with a layer of fibers and binder forming a composite structure protecting the steel from corrosion.

7. The Method of claim 1, wherein the bar consists of steel fibers mixed with glass, basalt, carbon or other fibers to form a composite that both increases strength and protects the steel in the binder.

8. The method of claim 1, wherein the bar is rectangular with a preferred bending direction and enhanced pull out strength due to the adhesion of a pozzolan to surrounding cement.

9. The method of claim 1, where the bar has notches on the outer edges to enable locking with other rebar or forms making mechanical assembly possible without external fasteners.

10. The method of claim 1, where different sizes of rebar are color coded to allow ease of assembly and visual inspection.

11. The method of claim 1, wherein the holes and mechanical forms are impressed in the strips to allow ease of assembly with fasteners.

12. The method of claim 1, wherein the rebar is in the shape of a strip or ribbon with enhanced flexibility in the thin bending moment.

13. The method of claim 1, wherein the strip is split allowing the easy creation of interleaved baskets or cages with less labor and greater integration of vertical and horizontal sections of the rebar cage or structure.

14. The method of claim 1, wherein the strip is twisted along the long axis.

15. The method of claim 1, wherein strip can be close to the surface of the concrete structure without impacting surface strength due to the inert nature of the Fiber reinforcement and binder.

16. The method of claim 1, wherein the strip is split into sections allowing other strips to be inserted at 90 degrees or another angle, to provide mechanical interaction.

17. The method of claim 1, wherein the strip is mechanically bound together due to the modification of the shape allowing cages and meshes to be quickly woven.

18. The method of claim 1, wherein the rebar is bound with dicyclopentadiene or other bonding agent to bind the fibers together and the surface is then coated with a pozzolan.

19. The method of claim 1, wherein the pozzolan comprises one of: fly ash, silica fume, rice husk ash, slag cement, metakaolin.

20. The method of claim 1, wherein the pozzolan comprises one of clinker, cement, clay, and volcanic rock.
